(19) United States
(12) Patent Application Publication
(10) Pub. No.: US 2009/0151485 A1
(43) Pub. Date: Jun. 18, 2009

(54) METHOD AND SYSTEM FOR RETRACTING AN UNBALANCED MASS IN A VIBRATOR

(75) Inventors: MARTIN R. PAIS, NORTH BARRINGTON, IL (US); MANGARAJU VUPPALA, LAKE ZURICH, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/954,501

(22) Filed: Dec. 12, 2007

(51) Int. Cl. B06B 1/16

(52) U.S. Cl. 74/61

(57) ABSTRACT

A vibrator assembly (108) comprising a shaft (112) that is connected to a motor (110), to produce vibration in a communication device (500), is disclosed. The shaft (112) includes a track that defines a path with a first component that travels circumferentially around the shaft (112), and a second component that travels along the length of the shaft (112). The shaft (112) rotates due to a rotational force that is generated when the motor (110) is activated. The unbalanced mass (114) travels along the track towards an end of the path proximate a free-end of the shaft (112) when the motor (110) is activated, and retracts due to a biasing force from a tension device (212) when the motor (110) is deactivated.

### FIELD OF THE INVENTION

The present invention generally relates to a method and system for producing a vibration, and more specifically, to a vibrator system and corresponding method, which automatically extends and retracts an unbalanced mass used to produce the vibration relative to a motor housing depending upon the current operating state of vibrator system.

### BACKGROUND OF THE INVENTION

A typical vibrator assembly includes a motor, a shaft connected to the motor, and an unbalanced mass located proximate the end of the shaft, which is rotated by the motor via the shaft for purposes of creating a vibration. The vibrator assembly is often used in communication devices to provide haptic (i.e. tactile) feedback to a user. Currently, many communication devices, for example, mobile phones and pagers, use a vibrator assembly to produce a vibration, which can be felt while holding and/or interacting with the device, such as during call alerts in place of or in addition to an audible alert, when a call or a message is received. When such alerts are received, the motor of the vibrator assembly is activated and the shaft connected to the motor starts rotating due to the action of a rotational force produced by the motor. The unbalanced mass attached to the shaft also starts rotating when the motor is activated, which causes the communication device to vibrate.

Generally, the unbalanced mass is positioned a distance away from the motor, so as to avoid the unbalanced mass from hitting or rubbing up against the motor as the unbalanced mass is rotated. However, extending the unbalanced mass a distance away from the motor housing can expose a portion of the shaft to increased stresses. For example, in certain situations, when the communication device is dropped accidentally, there is a risk of the exposed portion of the shaft being bent due to the distance that the unbalanced mass proximate the end of the shaft extends away from the point along the length of the shaft that is supported by the motor housing. Traditionally, the shaft is made of a material, such as metal, which can bend or break under a sufficiently large amount of applied force. Not only does the extended length expose more of the shaft, but it also moves the associated unbalanced mass a greater distance away from the motor housing support, such that any force resulting from a sudden change in velocity will result in a greater amount of torque applied to the shaft at the single supported end of the extended portion of the shaft. In some instance, not only might the shaft be deformed, bent or broken, but it is alternatively and/or additionally possible that the unbalanced mass may get knocked off of the shaft, thereby damaging the communication device and/or affecting the ability of the device to produce further vibrational effects.

In an attempt to avoid the bending or deformation of the shaft, as mentioned above, some designs have attempted to make use of high-grade material having a higher tensile strength from which the shaft is manufactured. However, for at least some kinds of impact, various tests conducted on shafts composed of different materials have shown that shafts composed of lower tensile strength materials generally have higher fracture resilience than those made of higher tensile strength materials. In other words, while some harder materials had a greater resistance to bending, they often showed a greater propensity to crack or break under the same circumstances. Further, it has also been demonstrated that in at least some expected usage conditions, many of the higher grade materials, including some kinds of steel with higher tensile strength, may not be able to withstand the maximum anticipated stress likely to be encountered when the device is dropped. A higher-grade material can also increase the cost of the shaft, and consequently that of the vibrator assembly.

In light of the facts mentioned above, there exists a need for a method and system for preventing and/or reducing the possibility of the shaft of the vibrator assembly getting damaged or bent in the event a communication device comprising a vibrator assembly is dropped.

### SUMMARY OF THE INVENTION

The present invention provides a vibrator assembly, for use in a communication device. The vibrator assembly includes a motor and a shaft that is connected to the motor. The shaft includes a track that defines a path having a first component and a second component. The first component travels at least partially circumferentially around the shaft and the second component travels at least partially along the length of the shaft. An unbalanced mass is connected to the shaft of the vibrator assembly. This unbalanced mass includes a coupling for engaging and traveling along the track of the shaft when the shaft rotates due to the action of the rotational force generated when the motor is activated. The rotational speed of the unbalanced mass is less than the rotational speed of the shaft because of the rotational inertia of the unbalanced mass when the shaft is initially rotationally accelerated. The unbalanced mass travels along the track towards the end of the path proximate a free end of the shaft when the unbalanced mass rotates at a speed that is less than the rotational speed of the shaft. The vibrator assembly includes a tension device with a first end that is coupled to the shaft and a second end that is coupled to the unbalanced mass. The unbalanced mass retracts under the action of a biasing force from the tension device when the motor is deactivated.

The present invention further provides a communication device, which includes a vibrator assembly, which includes a motor and a shaft that is connected to the motor. The shaft includes a track that defines a path traveling at least partially circumferentially around the shaft and a second component that travels at least partially along the length of the shaft. An unbalanced mass, which includes a coupling, is connected to the shaft of the vibrator assembly. The coupling facilitates the process of the unbalanced mass traveling along the track of the shaft when the shaft is rotated. The shaft rotates under an action of a rotational force that is generated when the motor is activated. The rotational speed of the unbalanced mass is less than that of the shaft due to the rotational inertia of the unbalanced mass when the shaft is initially rotationally accelerated. The unbalanced mass travels along the track toward the end of the path proximate a free end of the shaft when the unbalanced mass rotates at a speed that is less than the rotational speed of the shaft. The vibrator assembly includes a tension device with a first end that is coupled to the shaft and a second end that is coupled to the unbalanced mass. The unbalanced mass retracts due to the action of the biasing force from the tension device when the motor is deactivated.

The present invention still further provides a method for producing vibrations in a device that includes a motor, a shaft and an unbalanced mass. The method includes activating the motor that generates a rotational force applied to the shaft, which is connected to the motor. The shaft rotates due to the applied rotational force, which in turn rotates the unbalanced mass. The unbalanced mass is displaced from a rest position along a length of the shaft towards an end of the path proximate a free-end of the shaft when the unbalanced mass initially has a rotational speed that is less than the rotational speed of the shaft, due to a rotational inertia of the unbalanced mass. The shaft including a path to which the unbalanced mass is coupled and along which the unbalanced mass can travel, the path having a first component which travels circumferentially at least partially around the shaft and a second component which travels at least partially along a length of the shaft.

In at least one embodiment, upon reaching the end of the path, the unbalanced mass is rotated with no further displacement along the length of the shaft.

In at least a further embodiment, the unbalanced mass is biased with a biasing force from a tension device having a first end coupled to the shaft and a second end coupled to the unbalanced mass. When the motor is deactivated, the unbalanced mass retracts due to the action of the biasing force from the tension device.

These and other features, as well as the advantages of this invention, are evident from the following description of one or more embodiments of this invention, with reference to the accompanying figures.

### BRIEF DESCRIPTION OF THE FIGURES

The present invention is illustrated by way of example, and not limitation, in the accompanying figures, in which like references indicate similar elements, and in which:

FIG. 1 illustrates a block diagram of an exemplary device incorporating a vibrator assembly where various embodiments of the present invention can be applicable;

FIG. 2 illustrates a more detailed view of an exemplary vibrator assembly, which provides for an unbalanced mass that is displaced toward an end of the shaft when a motor is activated, in accordance with an embodiment of the present invention;

FIG. 3 illustrates a further exemplary embodiment of a vibrator assembly, which provides for an unbalanced mass that is displaced toward the end of a shaft when a motor is activated in an exemplary vibrator assembly, in accordance with the present invention;

FIG. 4 illustrates the retraction of an unbalanced mass in an exemplary vibrator assembly when the motor is deactivated, in accordance with an embodiment of the present invention;

FIG. 5 illustrates a partial block diagram of a device where various embodiments of the present invention can be applicable; and

FIG. 6 is a flow diagram illustrating a method for producing vibrations in a device, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular vibrator assembly, in accordance with various embodiments of the present invention, it should be observed that the present invention resides primarily in combinations of the apparatus components of the vibrator assembly, related to the lateral displacement of the unbalanced mass within the vibrator assembly. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, relational terms such as ‘first’ and ‘second’, and the like, may be used solely to distinguish one entity from another, without necessarily requiring or implying any actual relationship or order between such entities. The terms ‘comprises’, ‘comprising’, or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by ‘comprises . . . a’ does not, without more constraints, preclude the existence of additional identical elements in the process, method, article or apparatus that comprises the element. The term ‘another’, as used herein, is defined as at least a second or more. The term ‘including’ as used herein, is defined as comprising.

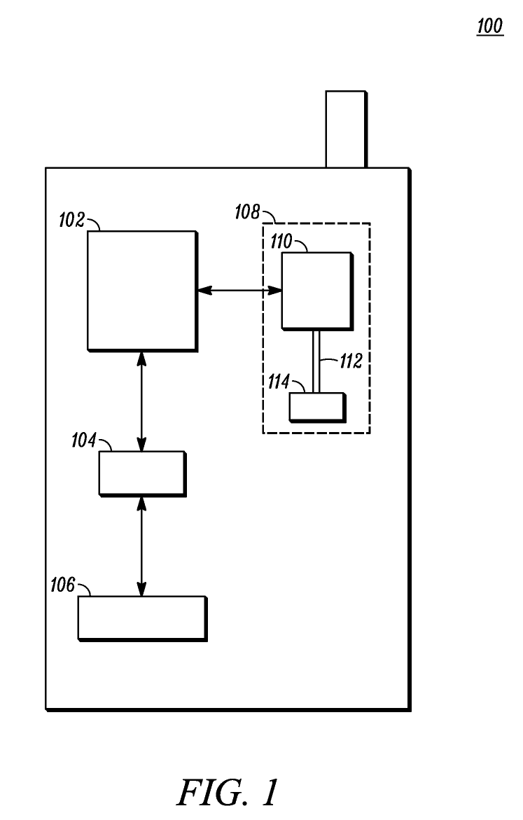

FIG. 1 illustrates an exemplary device 100, where various embodiments of the present invention can be applicable. In at least one embodiment, the device 100 can be a portable electronic device. Examples of the portable electronic device 100 include, but are not limited to, a pager, a laptop and a Personal Digital Assistant (PDA). In another embodiment, the device 100 can be a radio frequency telephone. Examples of the radio frequency telephone can include, but are not limited to, a mobile phone and/or a cellular telephone. For an embodiment, the device 100 includes a microprocessor 102, an analog-to-digital converter (ADC) 104, a microphone 106 and a vibrator assembly 108. The vibrator assembly 108 includes a motor 110, a shaft 112 that is connected to the motor 110, and an unbalanced mass 114 that is coupled to the shaft 112. Examples of the motor 110 include, but are not limited to, a Permanent Magnet Direct Current (PMDC) motor and a Switched Reluctance Motor (SRM). The vibrator assembly 108 produces vibrations in the device 100 as soon as the device 100 detects a signal that is associated with a functionality of the device 100. Examples of the functionality of the device 100 include, but are not limited to, an incoming call or a message to the device 100. Examples of the message can be a text message or a voice message. The shaft 112 includes a track that defines a path of travel, that in addition to extending at least partially along the length of the shaft, simultaneously, at least partially circumferentially traverses the shaft, in a manner similar to the threads of a screw. In essence, the path can be equated to a vector, which has multiple constituent components including a first component and a second component. The first component represents the portion of the path that travels circumferentially at least partially around the shaft 112. The second component represents the portion of the path that travels at least partially along the length of the shaft. The unbalanced mass 114 connected to the shaft 112 includes a coupling that facilitates the engaging and traveling of the unbalanced mass 114 along the track of the shaft 112.

The motor 110 is activated when the production of a vibrational effect, such as some instances when a signal corresponding to an incoming call or a message to the device 100 is detected by the device 100. As soon as the motor 110 is activated, the shaft 112 connected to the motor 110 starts rotating due to the action of a rotational force applied to the shaft by the motor, which is generated when the motor 110 is activated. The unbalanced mass 114 connected to the shaft 112 via the coupling starts rotating on the shaft 112 as the frictional interaction between the shaft and the coupling of the unbalanced mass imparts some of the rotational force applied to the shaft by the motor to the unbalanced mass. At least initially, the unbalanced mass rotates at a speed that is less than the rotational speed of the shaft 112, due to the rotational inertia of the unbalanced mass 114. In turn, the unbalanced mass 114 travels circumferentially and consequently laterally along the track of the shaft 112 from a rest position towards an end of the path proximate a free-end of the shaft 112 when the rotational speed of the unbalanced mass 114 is less than that of the shaft 112. The unbalanced mass 114 rotates at a position closer to the end of the path proximate a free-end of the shaft, and generally produces a vibration in the device 100 for as long as the motor 110 remains activated. The motor 110 is deactivated when the vibrational drive signal is removed from the motor. When the motor 110 is deactivated, the unbalanced mass 114 generally spins down with the shaft, and in so doing generally reverses its direction of travel relative to the track and travels along the track of the shaft towards the rest position. The unbalanced mass 114 remains at the rest position until the device 100 detects another incoming call or message in the device 100.

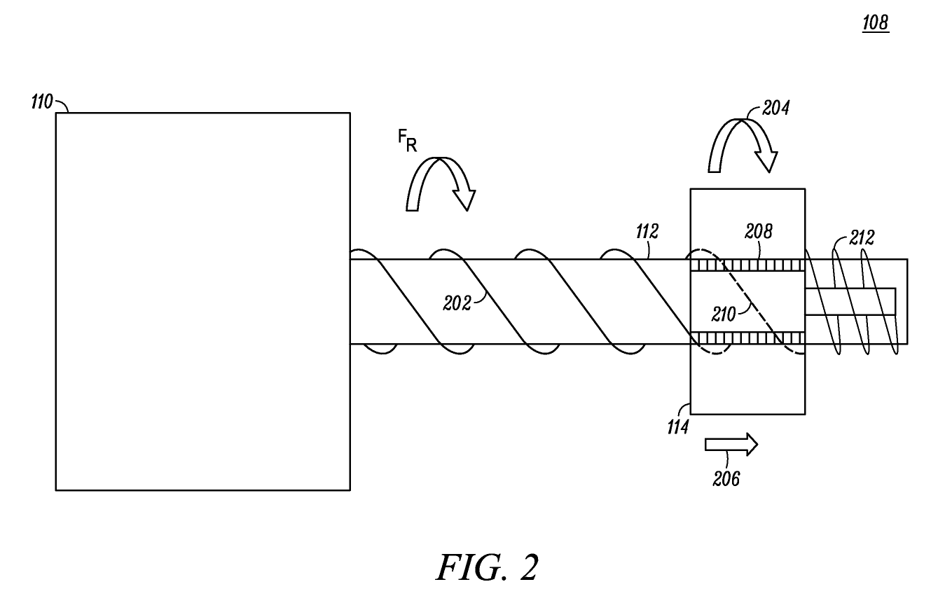

Some of the retraction of the unbalanced mass back towards the rest position can be the result of the unbalanced mass having a rotational speed, which typically will now exceeds the rotational speed of the shaft as the shaft is only loosely coupled to the unbalanced mass. The frictional interaction between the shaft and the unbalanced mass has typically not yet damped the rotational momentum of the mass. Further movement toward a rest position can be facilitated through the application of biasing forces, such as a force produced by a tension device (i.e. spring), illustrated in FIGS. 2-5.

FIG. 2 illustrates the displacement of an unbalanced mass 114 in an exemplary vibrator assembly 108, in accordance with an embodiment of the present invention. The vibrator assembly 108 includes a motor 110, a shaft 112 that is connected to the motor 110, and an unbalanced mass 114 that is coupled to the shaft 112.

The shaft 112 includes a track that defines a path associated with a vector having with a first component and a second component. The first component defines travel in a circumferential direction that extends at least partially around the shaft 112 illustrated by arrow 204. The second component defines travel in a longitudinal direction that extends at least partially along the length of the shaft 112, illustrated by arrow 206. In at least one embodiment, the track of the shaft 112 has an external helical screw form 202. In one such embodiment, the external helical screw form 202 has three to four threads per inch (tpi), resulting in a thread pitch in the range of 6 to 8 millimeters. Further, such an embodiment might have a 7° helical angle between the external threads.

The unbalanced mass 114 connected to the shaft 112 includes a coupling 208 that facilitates the engaging and traveling of the unbalanced mass 114 along the track of the shaft 112. The coupling 208 has an internal helical screw form 210, which includes helical threads. In such an embodiment, the internal helical screw form 210 will have dimensions which generally correspond to external helical screw form 202 of the shaft. The external helical screw form 202 of the track of the shaft 112 and the internal helical screw form 210 of the coupling 208 have sufficiently loose tolerance to enable rotation of the unbalanced mass 114 relative to the shaft 112, when coupled together.

The vibrator assembly 108 also includes a tension device. In at least one exemplary embodiment, the tension device can be a spring. For another embodiment, the tension device can be a spring used in combination with a spacer. In many instances, the spacer represents an intermediate element, which can be used to reduce friction between elements, for example, between a spring and an unbalanced mass. In at least some instances, the spacer can include one or more fiber washers with a lubricant applied to them. In some instances, the width of the spacer can also be used to adjust the relative spacing of elements and account for certain tolerances during the manufacturing process. In the illustrated embodiment, the tension device is a spring 212, which is located co-axially with the shaft 112. The spring 212 has a first end that is coupled to a free end of the shaft 112 and a second end that is coupled to the unbalanced mass 114. Examples of the spring 212 can include a helical spring or a leaf spring.

As noted previously, a rotational force F_{R} (shown in FIG. 2) is generated when the motor 110 is activated, which rotates the shaft 112 connected to the motor 110. The unbalanced mass 114 is initially biased toward rotation with the shaft 112 via the frictional interaction between the shaft and the coupling of the unbalanced mass in direction 204. Generally, the unbalanced mass will have a speed which lags the speed of the shaft, such that initially upon activation of the motor, the unbalanced mass will have a rotational speed that is less than the speed of the shaft 112 due to the rotational inertia of the unbalanced mass 114 and the slidable coupling that frictionally interact which only partially imparts the rotational force of the motor to the unbalanced mass. In turn, the unbalanced mass 114 travels along the track of the shaft 112 in the direction 206, from a rest position towards an end of the path proximate the free-end of the shaft 112. If and when the unbalanced mass reaches the end of the path, the unbalanced mass will generally be accelerated up to the speed of the shaft as the end of the path will no longer allow the coupling to lag rotationally. To the extent that the motor continues to be engaged. The unbalanced mass 114 continues to be rotated at the end of the path proximate the free-end of the shaft 112 upon reaching the end of the path proximate the free-end of the shaft 112. The rotation of the unbalanced mass 114 at the end of the path proximate the free-end of the shaft 112 produces vibration. The spring 212 remains in a compressed state when the motor 110 is activated, as illustrated in FIG. 2. However, when the motor is deactivated, the spring 212 is allowed to return to an expanded state, as the unbalanced mass is biased back to a retracted or a non-displaced state, where the unbalanced mass returns to a position more proximate the motor housing.

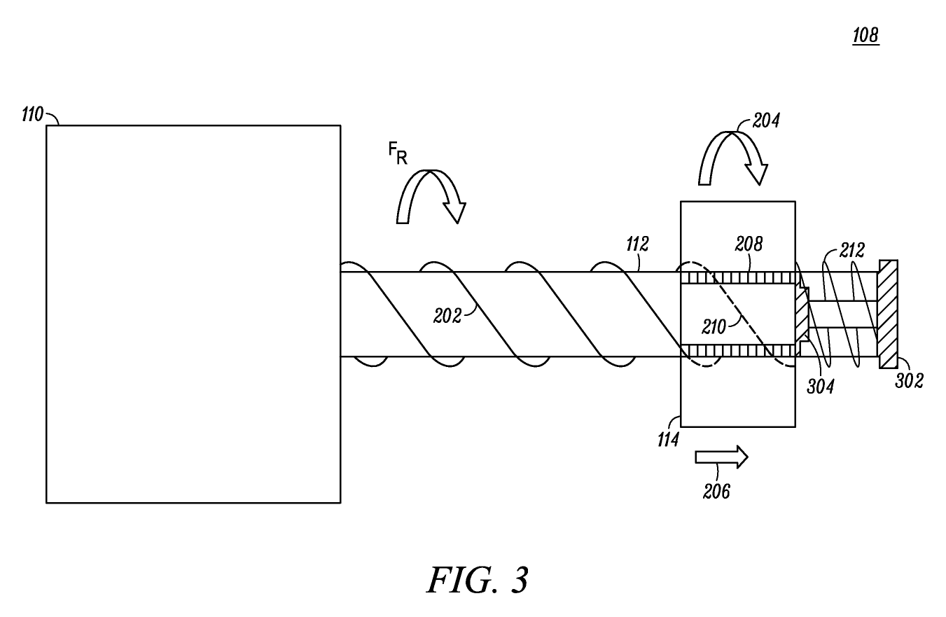

FIG. 3 illustrates the displacement of an unbalanced mass 114 in a further exemplary vibrator assembly 108 when the motor 110 is activated, in accordance with another embodiment of the present invention. In this embodiment, the end of the path proximate the free-end of the shaft 112 includes a hard stop 302. Further, in this embodiment, the tension device is a spring 212 that is used in combination with a spacer 304. The spring 212 has a first end that is coupled to the free-end of the shaft 112 and a second end that is coupled to the spacer 304. Similar to the embodiment illustrated in FIG. 2, the shaft 112 connected to the motor 110 rotates due to the action of a rotational force F_{R} in the direction 204, which in turn produces a rotation as well as a lateral displacement in the unbalanced mass. When the motor 110 is activated, the unbalanced mass 114 travels along the track of the shaft 112 from a rest position in the direction 206 towards the hard stop 302, which precludes further lateral movement of the unbalanced mass relative to the shaft. The hard stop 302 limits further movement of the unbalanced mass 114 in the direction 206. In this way, the unbalanced mass 114 can be positioned appropriately during its rotation, at a distance away from the free end of the shaft 112, to limit the amount of frictional interaction when the motor 110 is actuated to produce a vibrational effect.

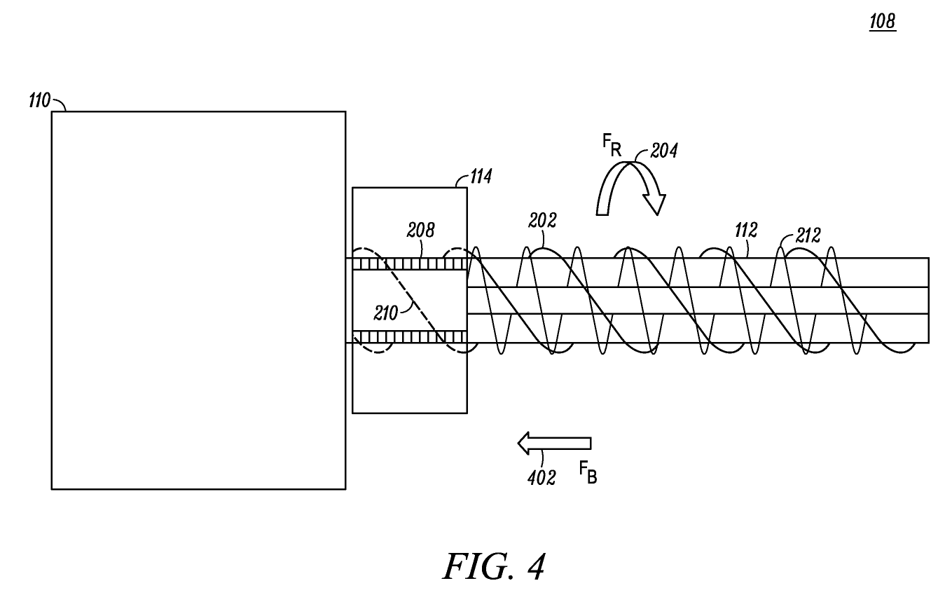

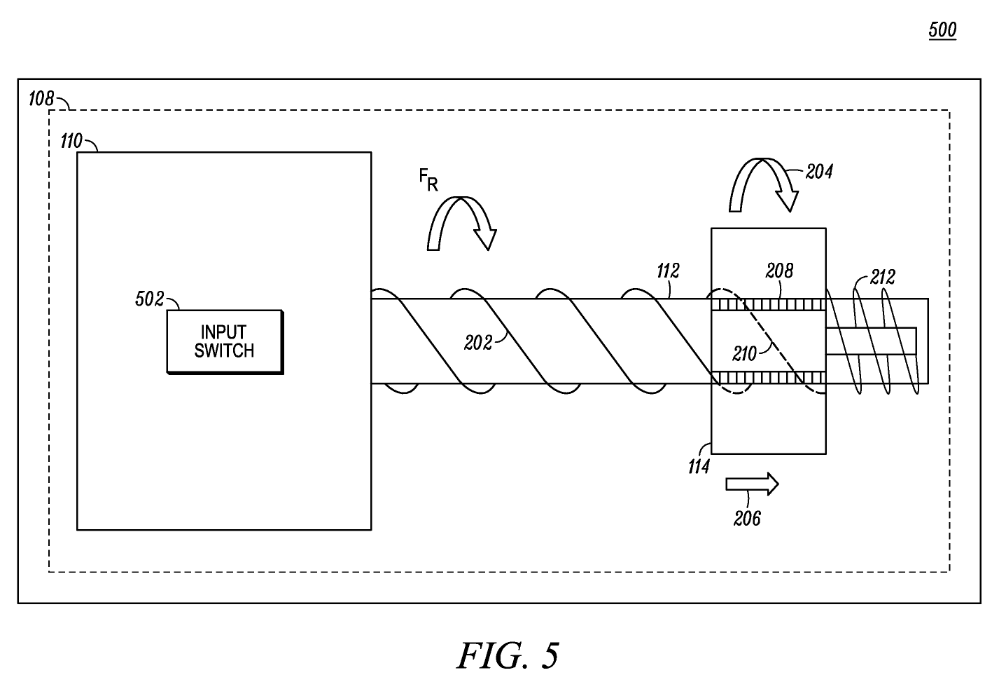

FIG. 4 illustrates the displacement of an unbalanced mass 114 in an exemplary vibrator assembly 108 when the motor 110 is deactivated, in accordance with an embodiment of the present invention. In this embodiment, the functionality of the vibrator system 108 is described when the motor 110 is deactivated. When the motor 110 is deactivated, the unbalanced mass 114 retracts from the end of the path proximate a free-end of the shaft 112 towards a rest position. The rest position of the unbalanced mass 114 is the position of the unbalanced mass 114 proximate the motor 110 (as shown in FIG. 4). The unbalanced mass 114 retracts due at least in part to a biasing force F_{B} (shown in FIG. 5). This biasing force can be provided by a tension device. In the illustrated embodiment, the tension device is a spring. For another embodiment, the tension device can be a spring that is used in combination with a spacer. As noted previously, the spacer represents an intermediate element, which can be used to reduce friction between the elements. In at least some instances, the spacer can include one or more fiber washers with a lubricant applied to them. In some instances, the width of the spacer can also be used to adjust the relative spacing of the elements and account for certain tolerances during the manufacturing process. In the illustrated embodiment, the spring 212 is located co-axially with the shaft 112. The spring 212 has a first end that is coupled to a free end of the shaft 112 and a second end that is coupled to the unbalanced mass 114. Examples of the spring 212 include a helical spring or a leaf spring. It will be apparent to a person ordinarily skilled in the art that any device that is capable of providing a biasing force can be used as a tension device. In the illustrated embodiment, the spring 212 is in an expanded state when the motor 110 is deactivated.

In at least some instances, the unbalanced mass 114 can be connected to the shaft 112, so that the rotation of the unbalanced mass 114 produces a vibration, and correspondingly produces a vibration that is relative to any structure to which the motor 110 is attached, e.g., a communication device.

FIG. 5 illustrates a communication device 500, where various embodiments of the present invention can be applicable. In at least one embodiment, the communication device 500 can be a portable electronic device. Several examples of different types of potential portable electronic devices are discussed in connection with FIG. 1. However, one skilled in the art will readily appreciate that the present invention could also be incorporated with other types of electronic devices without departing from the teachings of the present invention. The communication device 500 includes the vibrator assembly 108, which produces vibrations, such as some instances when a signal corresponding to an incoming call or message is detected by the communication device 500. In accordance with at least some embodiments, the motor 110 includes an input switch 502 for activating the motor 110, which can be coupled to an accelerometer (not shown in FIG. 5). The accelerometer can detect the free fall of the communication device 500 by measuring its acceleration. Examples of an accelerometer include, but are not limited to, a piezoelectric accelerometer and an electromechanical accelerometer. In at least some instances, a piezoelectric accelerometer can be used to produce a measurable change in a voltage across a dielectric, in response to varying amounts of mechanical stress, which can result from the acceleration of an associated mass being acted on by the force of gravity. The output of the accelerometer is coupled to the input switch 502. When the accelerometer detects the free fall of the communication device 500, the input switch 502 can be used to deactivate the motor 110, thereby allowing the unbalanced mass 114 connected to a shaft 112 of the motor 110 to retract toward a rest position proximate the motor 110. As a result, even if the communication device 500 is dropped when the motor 110 is active the fall can be detected and the motor 110 deactivated, such that the unbalanced mass 114 can retract, thereby increasing the chances that the shaft 112 is saved from being bent or damaged, during any subsequent impact.

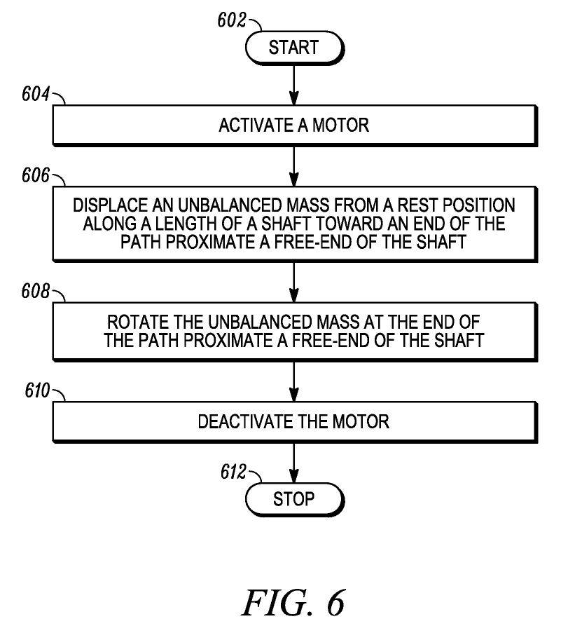

FIG. 6 is a flow diagram illustrating a method for producing vibrations in a communication device, for example, the communication device 500, in accordance with various embodiments of the present invention. The method is initiated at step 602. At step 604, a motor is activated. As soon as the motor 110 is activated, a shaft starts rotating due to the action of a rotational force ‘F_{R}’ (as shown in FIG. 2) that is generated when the motor 110 is activated. An unbalanced mass starts rotating with the shaft 112 at a speed that at least initially is less than the rotational speed of the shaft 112. The rotational speed of the unbalanced mass 114 is initially less than the rotational speed of the shaft 112 due to the rotational inertia of the unbalanced mass 114 when the shaft 112 is rotationally accelerated. The unbalanced mass 114 connected to the shaft 112 includes a coupling which in at least some instances includes an internal helical screw form 210. The coupling 208 facilitates the engaging and traveling of the unbalanced mass 114 along the shaft 112, which can include an external helical screw form 202. The external helical screw form 202 of the shaft 112 and the internal helical screw form 210 of the coupling 208 have sufficiently loose tolerance and/or clearance to enable rotation of the unbalanced mass 114 on the shaft 112.

At step 606, the unbalanced mass 114, connected to the shaft 112, is displaced from a rest position proximate the motor 110 towards an end of the path proximate a free-end of the shaft 112. In some embodiments, the end of the path proximate the free-end of the shaft can include a hard stop. The unbalanced mass 114 in some instances continues rotating and is displaced axially till the hard stop or the end of the path limits further movement of the unbalanced mass 114 in the axial direction. At step 608, upon reaching the end of the path, the unbalanced mass 114 is rotated proximate the free-end of the shaft 112. The rotation of the unbalanced mass 114 at the end of the path proximate the free-end of the shaft 112 produces a vibration in the communication device 500 until the motor is deactivated. When the motor 110 is deactivated, the unbalanced mass 114 retracts from the end of the path proximate the free-end of the shaft 112 to the rest position proximate the motor 110. In at least some instances, a tension device, for example, a spring 212 with a first end coupled to the shaft 112 and a second end coupled to the unbalanced mass 114 is used to provide a biasing force F_{B} to the unbalanced mass 114. The unbalanced mass 114 retracts to the rest position due to the action of a biasing force. The method terminates at step 612.

Various embodiments of the present invention, described above, provide the following advantages. In at least one embodiment, the method enables the lateral displacement of the unbalanced mass within the vibrator assembly, when the motor is deactivated or an acceleration of the device is detected, which might occur prior to an impact with the potential to break or deform the vibrator assembly. Consequently, when the device that includes the vibrator assembly is dropped, the unbalanced mass connected to the shaft in the vibrator assembly is or can be moved towards a retracted position, thereby reducing chances of the shaft being bent under the impact associated with the weight of the unbalanced mass.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A vibrator assembly comprising:
a shaft connected to a motor, the shaft including a track defining a path having a first component which travels circumferentially at least partially around the shaft and a second component which travels at least partially along a length of the shaft, wherein the shaft rotates under an action of a rotational force that is generated when the motor is activated; and
an unbalanced mass connected to the shaft, the unbalanced mass including a coupling for engaging and traveling along the track of the shaft, when the shaft is rotated, wherein when the motor is activated and the shaft is initially rotationally accelerated, the rotational speed of the unbalanced mass is less than the rotational speed of the shaft due to the rotational inertia of the unbalanced mass, such that when the unbalanced mass rotates at a speed less than the shaft, the unbalanced mass travels along the track toward an end of the path proximate a free-end of the shaft.

2. A vibrator assembly in accordance with claim 1 further comprising a tension device having a first end coupled to the free-end of the shaft and a second end coupled to the unbalanced mass, wherein when the motor is deactivated the unbalanced mass retracts under the action of a biasing force from the tension device.

3. A vibrator assembly in accordance with claim 2 wherein the tension device moves toward a compressed state when the motor is activated and moves toward an uncompressed state when the motor is deactivated.

4. A vibrator assembly in accordance with claim 2 wherein the tension device includes a spring and a spacer.

5. A vibrator assembly in accordance with claim 1 wherein the track has an external helical screw form and the coupling of the unbalanced mass has an internal helical screw form, such that the internal helical screw form of the coupling mates with the external helical screw form of the track.

6. A vibrator assembly in accordance with claim 1 wherein the end of the path proximate the free-end of the shaft includes a hard stop.

7. A vibrator assembly in accordance with claim 1 further comprising an input switch for activating the motor, further wherein the input switch deactivates the motor on detecting a free-fall of the device by an accelerometer coupled to the input power supply.

8. A communication device comprising:
a vibrator assembly comprising:
a shaft connected to a motor, the shaft including a track defining a path having a first component which travels circumferentially at least partially around the shaft and a second component which travels at least partially along a length of the shaft, wherein the shaft rotates under an action of a rotational force that is generated when the motor is activated; and
an unbalanced mass connected to the shaft, the unbalanced mass including a coupling for engaging and traveling along the track of the shaft, when the shaft is rotated, wherein when the motor is activated and the shaft is initially rotationally accelerated, the rotational speed of the unbalanced mass is less than the rotational speed of the shaft due to the rotational inertia of the unbalanced mass, such that when the unbalanced mass rotates at a speed less than the shaft, the unbalanced mass travels along the track toward an end of the path proximate a free-end of the shaft.

9. A communication device in accordance with claim 8 further comprising a tension device having a first end coupled to the free-end of the shaft and a second end coupled to the unbalanced mass, wherein when the motor is deactivated the unbalanced mass retracts under the action of a biasing force from a tension device.

10. A communication device in accordance with claim 9 wherein the tension device moves toward a compressed state when the motor is activated and moves toward an uncompressed state when the motor is deactivated.

11. A communication device in accordance with claim 9 wherein the tension device includes a spring and a spacer.

12. A communication device in accordance with claim 8 wherein the track has an external helical screw form and the coupling of the unbalanced mass has an internal helical screw form, such that the internal helical screw form of the coupling of the unbalanced mass mates with the external helical screw form of the track.

13. A communication device in accordance with claim 8 wherein the end of the path proximate the free-end of the shaft includes a hard stop.

14. A communication device in accordance with claim 8 further comprising an input switch for activating the motor, further wherein the input switch deactivates the motor on detecting a free-fall of the device by an accelerometer coupled to the input power supply.

15. A communication device in accordance with claim 8 wherein the communication device is a portable electronic device.

16. A communication device in accordance with claim 8 wherein the communication device is a radio frequency telephone.

17. A method for producing vibrations in a device, wherein the device comprises a motor, a shaft and an unbalanced mass, the method comprising:
activating the motor for rotating the shaft attached to the motor, wherein the shaft rotates under an action of a rotational force that is generated when the motor is activated; and
rotating the unbalanced mass, where upon rotation of the unbalanced mass, the unbalanced mass is initially displaced from a rest position along a length of the shaft, the shaft including a path to which the unbalanced mass is coupled and along which the unbalanced mass can travel, the path having a first component which travels circumferentially at least partially around the shaft and a second component which travels at least partially along a length of the shaft, wherein when the motor is activated and the shaft is initially rotationally accelerated, the rotational speed of the unbalanced mass is less than the rotational speed of the shaft due to the rotational inertia of the unbalanced mass, such that when the unbalanced mass rotates at a speed less than the shaft, the unbalanced mass is displaced toward an end of the path proximate a free-end of the shaft.

18. A method in accordance with claim 17 wherein upon reaching the end of the path the unbalanced mass is rotated at the end of the path proximate the free-end of the shaft with no further displacement along the length of the shaft.

19. A method in accordance with claim 17 further comprising biasing the unbalanced mass with a biasing force from a tension device having a first end coupled to the shaft and a second end coupled to the unbalanced mass, wherein when the motor is deactivated the unbalanced mass retracts under the action of the biasing force from the tension device.
